(19) United States
(12) Patent Application Publication
(10) Pub. No.: US 2026/0171437 A1
(43) Pub. Date: Jun. 18, 2026

(54) ION EXCHANGE MEMBRANES FABRICATED FROM PLASTICS

(71) Applicants: The University of Chicago, Chicago, IL (US); UChicago Argonne, LLC, Chicago, IL (US)

(72) Inventors: Shrayesh N. Patel, Chicago, IL (US); Lu Zhang, Naperville, IL (US); Yuyue Zhao, Darien, IL (US)

(21) Appl. No.: 19/419,618

(22) Filed: Dec. 15, 2025

Related U.S. Application Data
(60) Provisional application No. 63/734,300, filed on Dec. 16, 2024.

(51) Int. Cl. H01M 8/0293; H01M 8/18

(52) U.S. Cl. CPC H01M 8/0293; H01M 8/188

(57) ABSTRACT

Provided are methods for fabricating ion exchange membranes. Such a method comprises exposing a polymer to an ionic functional group precursor under conditions to incorporate covalently bound ionic functional groups into the polymer, thereby providing a functionalized polymer comprising the covalently bound ionic functional groups; and forming the functionalized polymer into a membrane, thereby providing an ion exchange membrane that is permeable to some ions present in a fluid in contact with the membrane while impermeable to other ions present in the fluid. The ion exchange membranes and devices incorporating the membranes, e.g., redox flow batteries, are also encompassed by the present disclosure.

### CROSS-REFERENCE TO RELATED APPLICATION

The present application claims the priority benefit of U.S. Provisional Patent Application No. 63/734,300 filed on Dec. 16, 2024, the entire disclosure of which is incorporated herein by reference.

### BACKGROUND

Distributed stationary storage holds great promise to impact the US energy landscape by increasing renewable deployment, improving grid stability and efficiency, reducing dependence on imported fuels, and facilitating electric vehicle charging. Redox flow battery (RFB) systems represent an outstanding scientific and technical opportunity to address this challenge. However, despite the rapid development and pre-commercial scale demonstration, the state-of-art RFB systems are still not as competitive as mass-produced lithium-ion batteries in terms of system level cost, constraining them from commercial adoption. One of the most critical components of RFB systems is the ion exchange membrane, which blocks the active materials but allows ions to pass across to compensate for electrochemically generated charges. The dominating RFB ion exchange membrane is poly(perfluorosulfonic acid) (PFSA), i.e., Nafion. Such membranes are widely used in vanadium and other aqueous RFB systems due to reasonable ion selectivity, high conductivity, and outstanding chemical stability, but their cost is very high, accounting for up to 40% of the overall cost of vanadium RFB systems.

### SUMMARY

Provided are methods for fabricating ion exchange membranes. The ion exchange membranes and devices incorporating the membranes, e.g., redox flow batteries, are also encompassed by the present disclosure. By way of illustration, the Example below describes fabrication of an ion exchange membrane from a waste plastic material comprising polystyrene. An aqueous flow battery incorporating the fabricated ion exchange membrane exhibited a Coulombic efficiency (CE) of 98.5% and an energy efficiency (EE) of 86.9% and stable operation for 1200 cycles at 40 mA cm⁻². Even at 100 mA cm⁻², a CE of 99.9% and an EE of 71.1% were obtained. At the same time, based on an illustrative large-scale manufacturing process over a 10-year period, the cost associated with the illustrative method is only 2.94 $/m², orders of magnitude less than processes based on Nafion.

In one aspect, a method for fabricating an ion exchange membrane comprises exposing a polymer to an ionic functional group precursor under conditions to incorporate covalently bound ionic functional groups into the polymer, thereby providing a functionalized polymer comprising the covalently bound ionic functional groups; and forming the functionalized polymer into a membrane, thereby providing an ion exchange membrane that is permeable to some ions present in a fluid in contact with the membrane while impermeable to other ions present in the fluid.

In another aspect, an electrochemical device comprises an anode, an anolyte in contact with the anode, a cathode in electrical communication with the anode, a catholyte in contact with the cathode, and an ion exchange membrane separating the anolyte and the catholyte, wherein the ion exchange membrane comprises a functionalized waste polymer comprising a waste polymer obtained from a consumer product and ionic functional groups covalently bound to the waste polymer.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1A illustrates the upcycling of waste polystyrene in the fabrication of cation exchange membranes (CEMs) and their use in flow batteries. FIG. 1B shows ATR-FTIR spectra of various polystyrene (PS) materials; FIG. 1C is a zoom in of the spectra of FIG. 1B from 1250 cm⁻¹ to 720 cm⁻¹; FIG. 1D shows ¹H NMR spectra of virgin PS and expanded PS (expanded polystyrene) from a waste food dish. FIG. 1E shows the 1H NMR spectra of virgin HIPS (high impact polystyrene) and waste HIPS from a coffee cap. The inset details zoom to 4.0-6.0 ppm. FIG. 1F shows the 1H NMR spectra of virgin PS, virgin HIPS, and waste HIPS from a coffee cap zooming to 0.35-2.65 ppm.

FIG. 2A shows ATR-FTIR spectra of sulfonated PS-based materials. FIG. 2B shows the ASR of NF212 (Nafion 212) and PS-based cation exchange membranes in 2M KOH. FIG. 2C shows swelling and uptake of NF212 and PS-based cation exchange membranes in catholyte and anolyte. FIG. 2D is a plot of the thermal stability of EPS-based materials. FIG. 2E is a plot of the thermal stability of HIPS-based materials.

FIG. 3A is a schematic diagram of a flow battery including a PS-based CEM. FIG. 3B shows the CVs of 20 mM Na₄[Fe(CN)₆] (left curves) and 2,6-DHAQ (right curves) at a scan rate of 100 mV s⁻¹ on the glassy carbon electrode. FIG. 3C is a bar chart of the flow battery performance of different PS-based CEMs and NF212 at 40 mA cm⁻². FIG. 3D is a chart of the flow battery performance of different PS-based CEMs and NF212 at different current densities from 40 mA cm⁻² to 100 mA cm⁻². FIG. 3E shows polarization curves of different PS-based CEMs and NF212 at 50% SoC. FIG. 3F shows polarization curves of different PS-based CEMs and NF212 at different SoCs. FIG. 3G shows the cycling performance of the flow battery with S-W-dish at 40 mA cm⁻².

FIG. 4A illustrates an illustrative process for industrial manufacturing of upcycling wasted PS-based CEMs. FIG. 4B outlines the cost analysis of the illustrative process. FIG. 4C shows a cash flow representation of the illustrative process over time. Each arrowed line depicts the expenses for specific categories, while inclined lines indicate changes in expenditures over time. FIG. 4D shows a cost percentage histogram for each category with the numbers atop the bars representing the cost contributions of individual categories.

### DETAILED DESCRIPTION

Provided are methods for fabricating ion exchange membranes, e.g., dense (non-porous) ion exchange membranes. Ion passage through dense membranes is achieved by percolating ion-aggregated domains facilitating ion transport. The ion exchange membranes and devices incorporating the membranes, e.g., redox flow batteries, are also encompassed by the present disclosure. The fabrication methods comprise functionalizing a polymer with ionic functional groups to provide a functionalized polymer and forming the functionalized polymer into a membrane. The polymer to be functionalized refers to a chemical molecule composed of repeating units derived from monomers. Thus, the present methods make use of already synthesized polymers, i.e., pre-synthesized polymers. This distinguishes the present methods from existing techniques for fabricating ion exchange membranes based on synthesizing polymers via polymerization reactions of monomers. The present methods may be characterized as not involving such polymerization reactions.

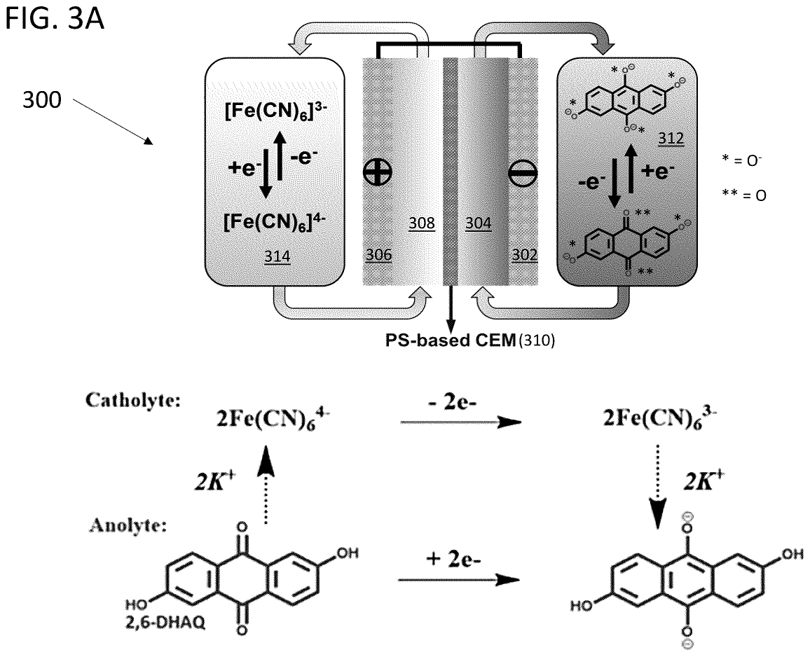

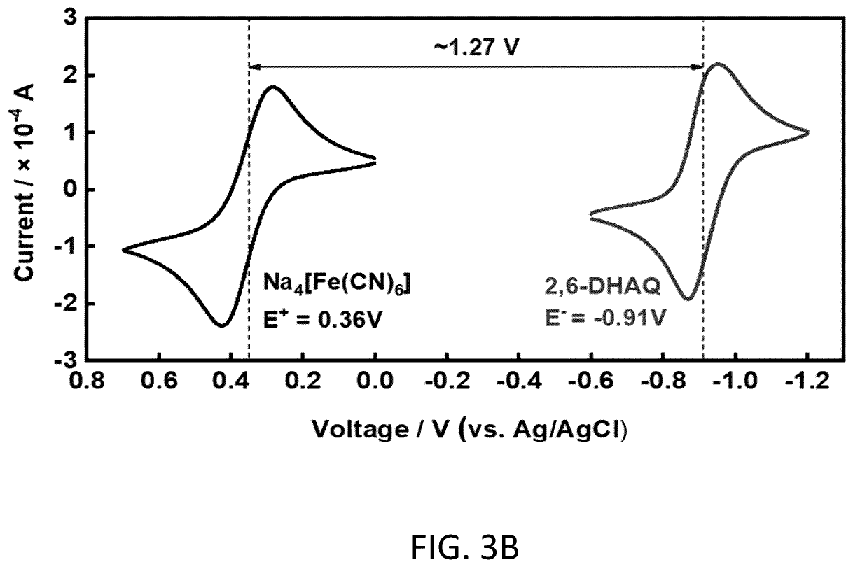

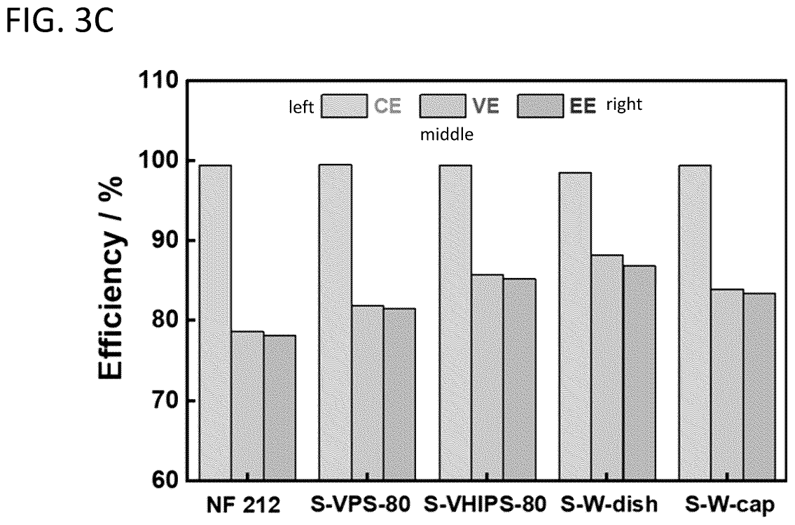

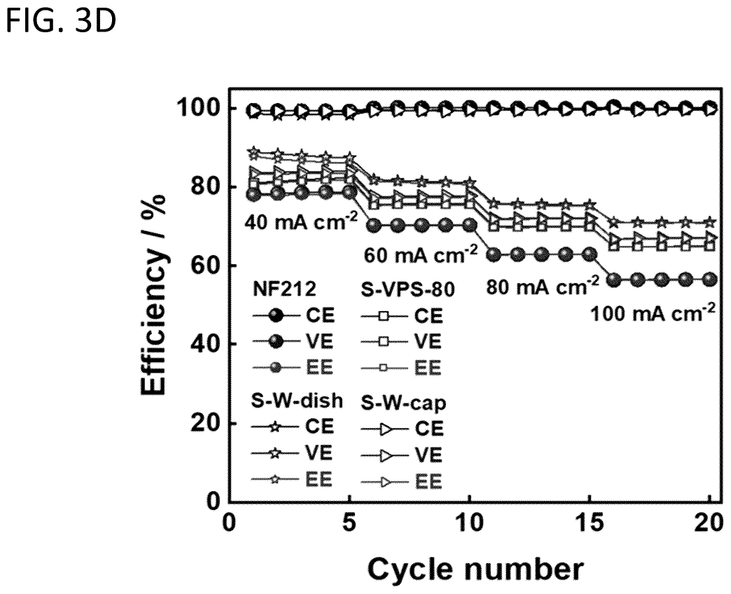

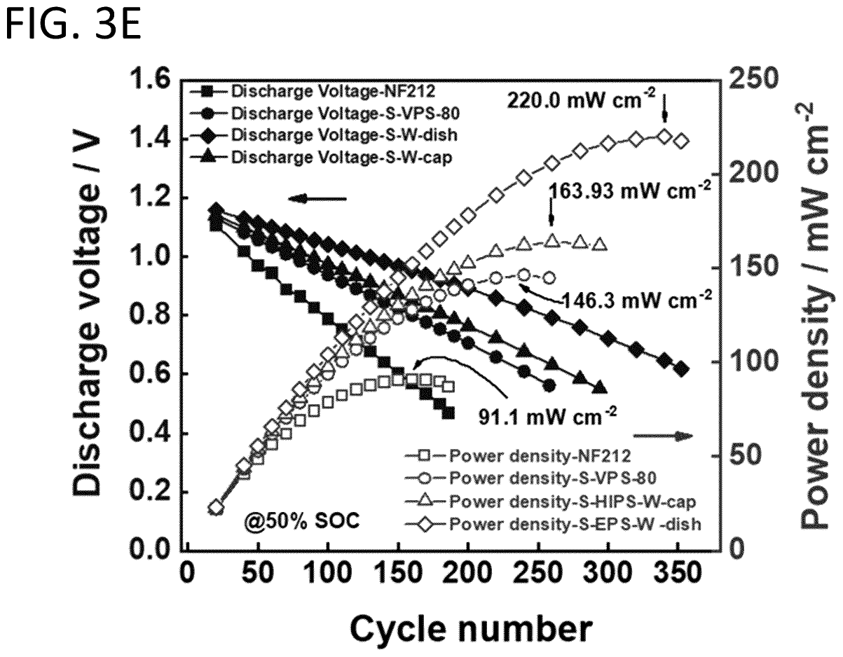

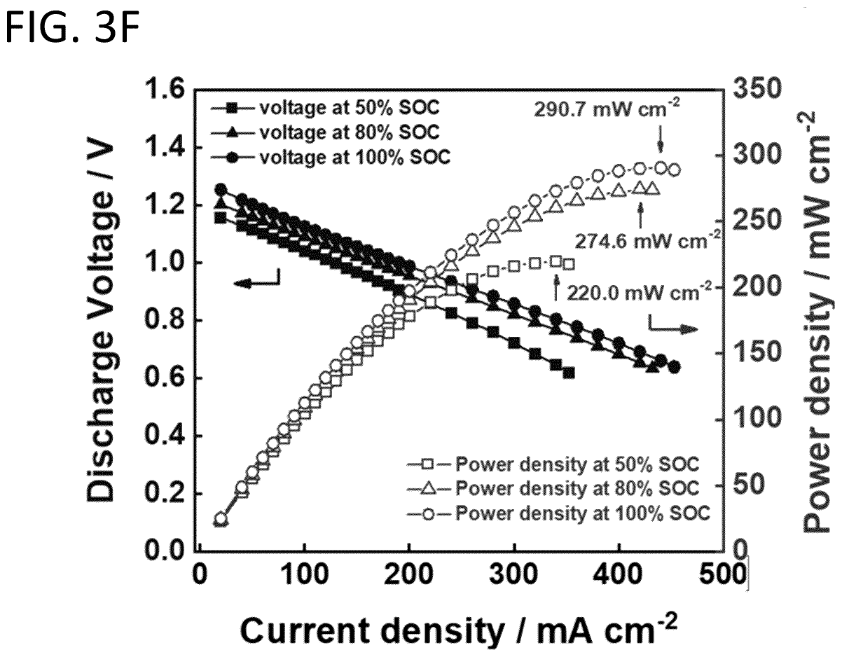

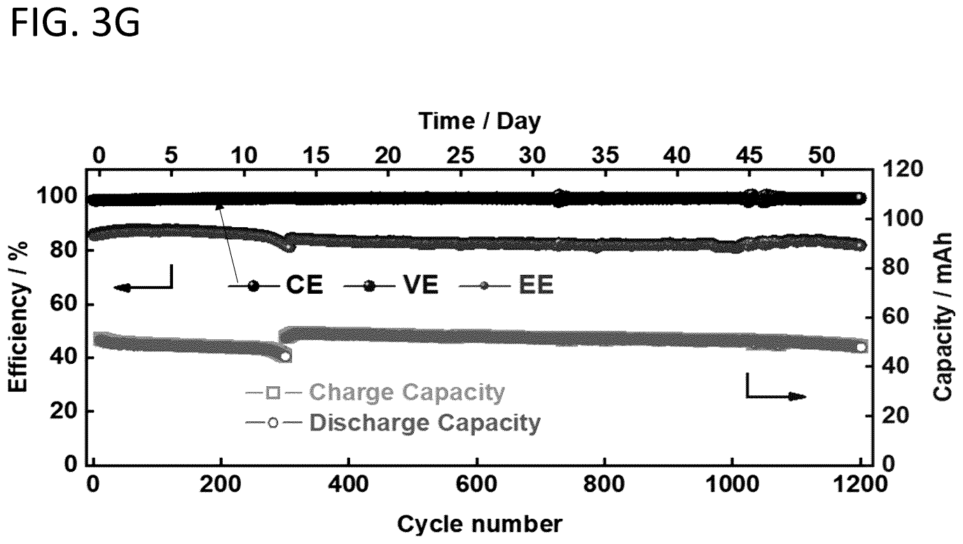

In embodiments, the polymer to be functionalized by the present methods does not comprise any ionic functional groups prior to carrying out the present methods. By “ionic functional group,” it is meant a chemical group that is capable of carrying a charge under the conditions that the ion exchange membrane is being used, including one that is charged under such conditions. This includes the operating conditions of any of the disclosed redox flow batteries, e.g., the aqueous redox flow battery of FIG. 3A. The term “ionic functional group” encompasses the group in its charged state and its neutral state due to association with a counter ion. In other embodiments, the polymer to be functionalized may comprise ionic functional groups, but not any of the specific ionic functional groups described below (e.g., sulfonate, carboxylate, quaternary ammonium).

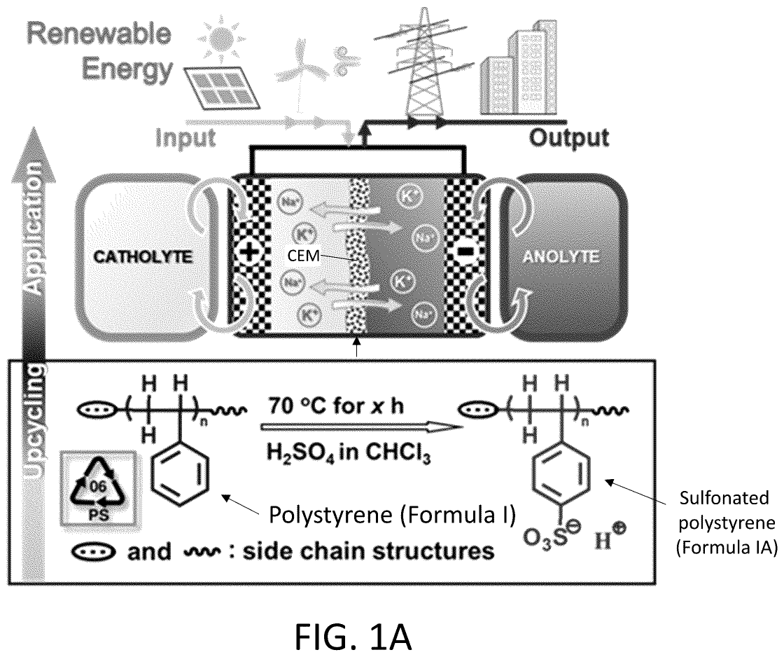

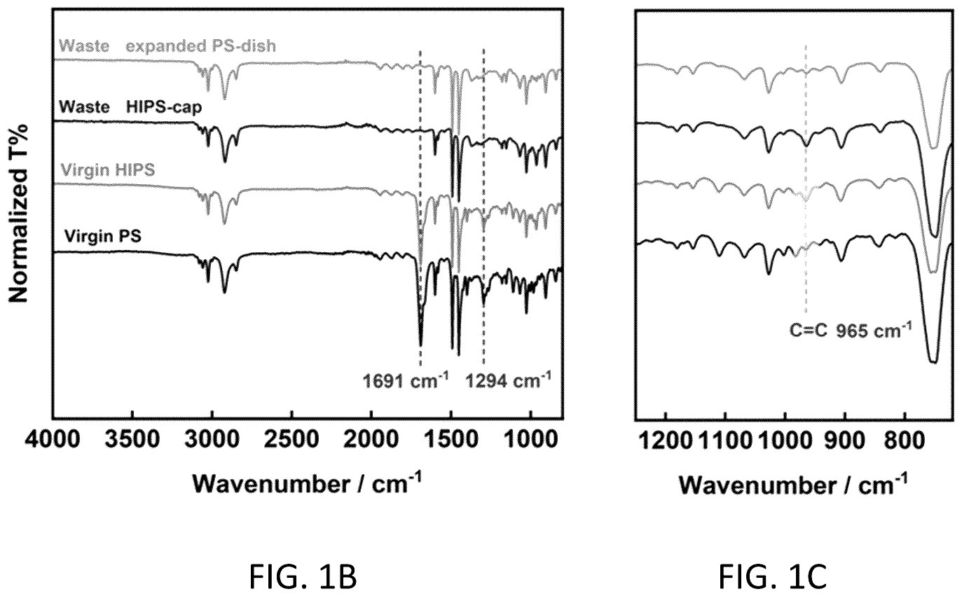

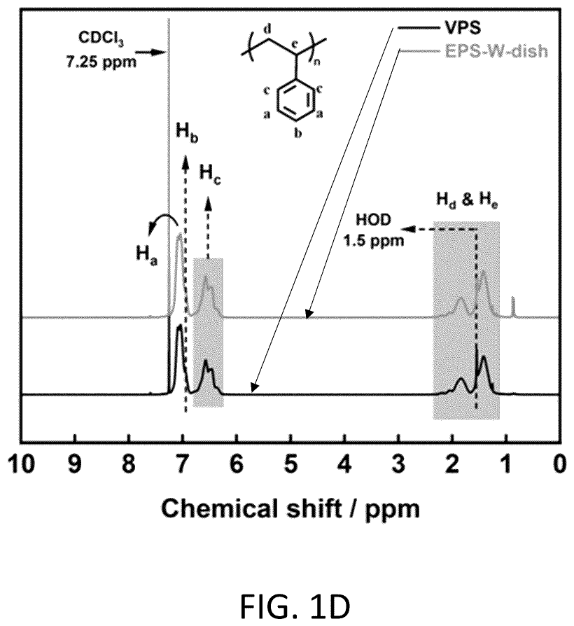

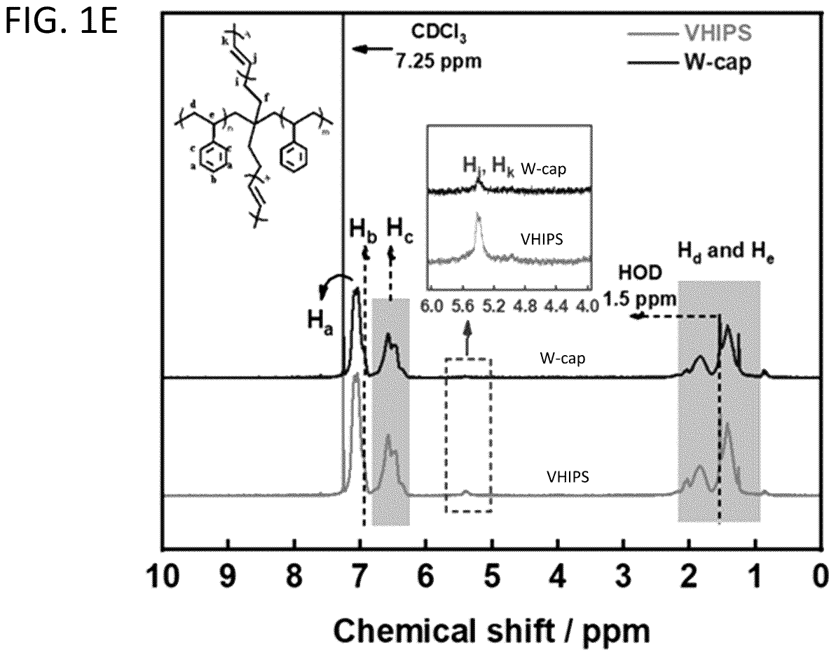

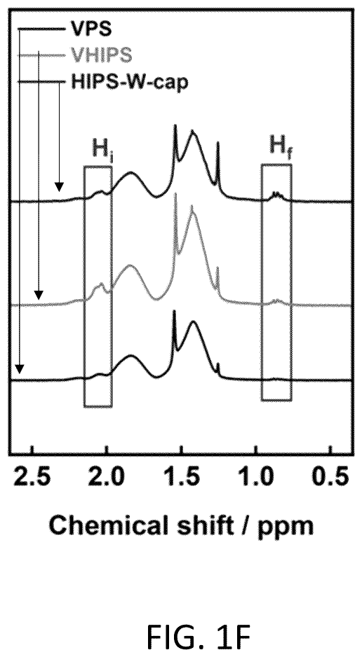

Various polymers may be functionalized by the present methods, including aromatic polymers comprising aromatic groups, e.g., benzene. In embodiments, the polymer is a polystyrene. In embodiments, the polystyrene may be represented by Formula I as shown in FIG. 1A. The polymer being used, e.g., polystyrene, may be a homopolymer (e.g., composed only of styrene monomers as in Formula I) or a copolymer (e.g., composed of styrene monomers and comonomers other than styrene, i.e., a polystyrene copolymer). The polymer may be characterized by its type, which may refer to the specific process used to synthesize the polymer. For example, the polystyrene may be expanded polystyrene (EPS) or high impact polystyrene (HIPS), which each have specific, different properties derived from the particular process used to synthesize each. Other aromatic polymers besides polystyrene may be used, including acrylonitrile butadiene styrene (ABS), Styrene Ethylene Butylene Styrene polymer (SEBS), polyether sulfone (PES), and polyphenylene oxide (PPO). A single type of polymer may be used or multiple, different types of polymers. In embodiments, polymers that are not used include one or more of polyethylene terephthalate (PET), polyethylene (PE), polypropylene (PP), and polyvinyl chloride (PVC).

The polymer to be functionalized by the present methods may be “virgin” polymer, which refers to pure, as-synthesized polymer that has not been further processed for use in a particular application (whether the virgin polyamide has been used or not). However, generally, the polymer is “waste” polymer, which refers to a polymer derived from a consumer product (whether that consumer product has actually been used or not). In such embodiments, the waste polymer may be one component of a plastic material that may include other components. The plastic material may have been processed for use in a particular consumer product (e.g., a food or beverage container or cap). Thus, the plastic material itself may be the consumer product. In such embodiments, the plastic material may be processed prior to carrying out the functionalization, e.g., physically processed by chopping, grinding, milling, etc.

Waste polymer (or a plastic material comprising waste polymer) may be distinguished from virgin polymer by using various techniques. For example, as shown in FIG. 1B, infrared spectroscopy may be used to distinguish waste polymer from virgin polymer on the basis of chemical structure. Specifically, FIG. 1B shows that waste polystyrene derived from consumer products (“waste expanded PS-dish” and “waste HIPS-cap”) is characterized by the absence of a peak at 1691 cm⁻¹, which is present in virgin polystyrene (“virgin HIPS” and “virgin PS”). As another example and as described in the Example, below, gel permeation chromatography may be used to distinguish waste polymer from virgin polymer on the basis of polydispersity index (PDI). Specifically, waste polystyrene derived from the consumer products is characterized by having a higher PDI as compared to virgin polystyrene, e.g., at least 1.3 times, at least 1.4 times, at least 1.5 times higher PDI, or a range between any of these values. This includes having a PDI of at least 3.00, at least 3.20, at least 3.40, or a range between any of these values. Other techniques which may be used to distinguish waste polymer from virgin polymer include FTIR and NMR. Functionalized waste polymer and functionalized virgin polymer may also be distinguished on this basis, e.g., higher PDI for functionalized waste polymer versus functionalized virgin polymer.

The functionalization step of the present methods refers to inducing chemical reactions involving the polymer to incorporate covalently bound ionic functional groups into the polymer. Various ionic functional groups may be used depending upon the desired application for the ion exchange membrane. The ionic functional groups may be anionic functional groups, e.g., —SO₃⁻ (sulfonate). The “-” refers to the covalent bond between the sulfonate group and the polymer. This covalent bond may be the covalent bond between the sulfonate group and a benzene ring of the polymer, i.e., the covalent bond between a carbon atom of the benzene ring and the sulfur atom of the sulfonate group. Other ionic functional groups may be used, including —CO₂⁻ (carboxylate). Cationic functional groups may be used, e.g., —NH₄⁺ (quaternary ammonium). In these other ionic functional groups, the “-” has a meaning analogous to that described herein for the sulfonate group. Due to the ionic functional groups incorporated into the functionalized polymer, the fabricated membrane is rendered selectively permeable to ions present in a fluid in contact with the membrane. For example, by using sulfonate ionic functional groups, a membrane fabricated using such a functionalized polymer can allow cations (e.g., alkali metal cations) to pass through the membrane while blocking the passage of anions. That is, the membrane is permeable to the cations and impermeable to the anions.

The functionalization step may be carried out by exposing the polymer (or the plastic material comprising the polymer) to an ionic functional group precursor under conditions to induce the chemical reactions noted above. The precursor may comprise the desired ionic functional group. Sulfuric acid may be used as the precursor to provide covalently bound sulfonate groups. Functionalization may further comprise dissolving the polymer to form a solution prior to reacting with the precursor. The precursor may be added to the solution to form a reaction mixture. Any solvent that sufficiently solubilizes the polymer may be used, e.g., chloroform. The conditions used to induce the chemical reactions depend upon the selected polymer and ionic functional group. By way of illustration, heating for a period of time may be used to induce reactions between the polymer and the precursor in the reaction mixture. The temperature and period of time may be adjusted to achieve a desired degree of functionalization and/or a desired property for the ion exchange membrane. Similarly, the relative amounts of polymer and precursor may be adjusted to achieve a desired degree of functionalization and/or a desired property for the ion exchange membrane. Illustrative temperatures, reaction times, and relative amounts are provided in the Example, below.

As noted above, other ionic functional groups may be used, including carboxylate groups and quaternary ammonium groups. In these embodiments, reactive benzylic sites (e.g., benzyl halide groups) in the polymer may be reacted with the selected ionic functional group precursor to introduce the desired ionic group. For carboxylate ionic functional groups, the benzylic sites may be reacted with a haloacetic acid (or the salt or ester thereof), (e.g., chloroacetic acid, sodium chloroacetate) or with an unsaturated carboxylic monomer (e.g., acrylic acid, methacrylic acid, maleic acid/anhydride) as the ionic functional group precursors, followed by neutralization to the carboxylate form. For quaternary ammonium ionic functional groups, the benzylic sites may be reacted with tertiary amines (e.g., trimethylamine, triethylamine, N,N-dimethylethanolamine) or other C₁-C₆ trialkyl or hydroxyalkyl tertiary amines) as the ionic functional group precursors to form pendant benzyl quaternary ammonium groups with an appropriate counterion. The relative amounts of polymer and precursor and the conditions used to induce the reactions may be adjusted to achieve a desired degree of functionalization and/or a desired property for the ion exchange membrane.

The result of the functionalization step provides a functionalized polymer comprising covalently bound ionic functional groups. The functionalized polymer may be recovered from the reaction mixture, e.g., via precipitation and centrifuging. Rinsing and drying of the recovered functionalized polymer may be conducted as desired.

Using the functionalization of polystyrene with sulfuric acid as an illustrative example, FIG. 1A shows a schematic of the functionalization step resulting in the incorporation of covalently bound sulfonate groups onto the benzene rings of the polystyrene. The functionalized polystyrene may be represented by Formula IA.

Next, the present methods comprise formation of a membrane from the functionalized polymer. This may be carried out by dissolving the functionalized polymer in a solvent, e.g., N-methyl-2-pyrrolidone, to form a membrane casting solution. Various thin film techniques may be used to form the membrane, e.g., doctor blading. The amount of the functionalized polymer in the membrane casting solution may be adjusted to achieve a desired property for the ion exchange membrane. Illustrative amounts are provided in the Example, below. Drying may be applied as desired, e.g., to remove the solvent used to form the membrane casting solution. The membrane may be characterized as having a two-dimensional, planar morphology having a thickness and lateral dimensions significantly greater than the thickness. The thickness depends upon the desired application, but may be less than 100 mm, in a range of from 20 mm to 60 mm, or in a range of from 25 mm to 45 mm. In the membrane, the functionalized polymer forms a network of entangled chains, the surfaces of which define pores distributed throughout the network. The membrane may be free-standing, which refers to a continuous monolithic sheet that does not require a support substrate to maintain this form.

The ion exchange membranes fabricated by the present methods may be characterized by various properties, including area specific resistance (ASR) and ion exchange capacity (IEC). Other properties include permeability, swelling, and uptake, each of which may be with reference to a particular solution, e.g., a catholyte or an anolyte of a redox flow battery in which the ion exchange membrane is to be used. These properties may be measured as described in the Example, below. As noted above, conditions of the present methods may be adjusted to achieve desired values for these properties. Illustrative ion exchange membranes having illustrative values for these properties are provided in Table 2 of the Example, below.

The ion exchange membranes fabricated by the present methods are configured for use, and thus may be used, in any device involving the selective passage of ions based on charge. This includes an electrochemical device such as an aqueous or non-aqueous redox flow battery. In such devices, any of the present ion exchange membranes may be positioned at any interface at which it is desired to selectively pass ions based on charge. The basic components of an electrochemical device include an anode, an anolyte in contact with the anode, a cathode in electrical communication with the anode, a catholyte in contact with the cathode, and any of the disclosed ion exchange membranes separating the anolyte and the catholyte.

In embodiments, the electrochemical device is a redox flow battery. An illustrative redox flow battery 300 is shown in FIG. 3A. The battery 300 includes an anode 302, an anolyte 304 in contact with the anode 302, a cathode 306 in electrical communication with the anode 302, a catholyte 308 in contact with the cathode 306, and an ion exchange membrane 310 according to the present disclosure separating the anolyte 304 and the catholyte 308. The anolyte 304 and the catholyte 308 are aqueous electrolyte solutions comprising redox active ions (i.e., anions and/or cations that undergo oxidation and/or reduction reactions during the operation of the battery 300). Other chemical species (e.g., salts) that are not redox active during operation of the battery 300 may be used, e.g., potassium hydroxide (KOH). The anolyte 304 redox active ions are shown in FIG. 3A and are derived from 2,6-dihydroxyanthraquinone (2,6-DHAQ). The catholyte 308 redox active ions are also shown in FIG. 3A and are derived from Na₄[Fe(CN)₆]. The anolyte 304 and the catholyte 308 are stored in an anolyte storage tank 312 and a catholyte storage tank 314, respectively, both of which are in fluid communication with respective battery chambers containing the anolyte 304 and the catholyte 308. This allows the anolyte 304 and the catholyte 308 to be circulated through their respective battery chambers during operation of the battery 300. During charging of the battery 300, an electrical bias is applied across the anode 302 and the cathode 306. As anolyte 304 redox active ions pass over the anode 302, they undergo electrochemical reduction reactions, while the catholyte 308 redox active ions passing over the cathode 306 undergo electrochemical oxidation reactions. During discharging of the battery 300, the reverse occurs such that the anolyte 304 redox active ions undergo electrochemical oxidation reactions, while the catholyte 308 redox active ions undergo electrochemical reduction reactions. Operation of the redox flow battery 300 is further illustrated in FIG. 1A. As shown in FIG. 1A, the illustrative ion exchange membrane 310 (labeled CEM) allows the passage of Na⁺ and K⁺ cations while inhibiting the passage of anions.

The embodiment of the redox flow battery 300 shown in FIGS. 1A and 3A is not intended to be limiting. Variations are encompassed, e.g., solid electrolytes or non-aqueous electrolytes may be used. Other illustrative redox flow batteries in which the present ion exchange membranes may be used include vanadium redox flow batteries. Other illustrative devices in which the present ion exchange membranes may be used include electrodialysis systems, e.g., lithium extraction electrodialysis systems.

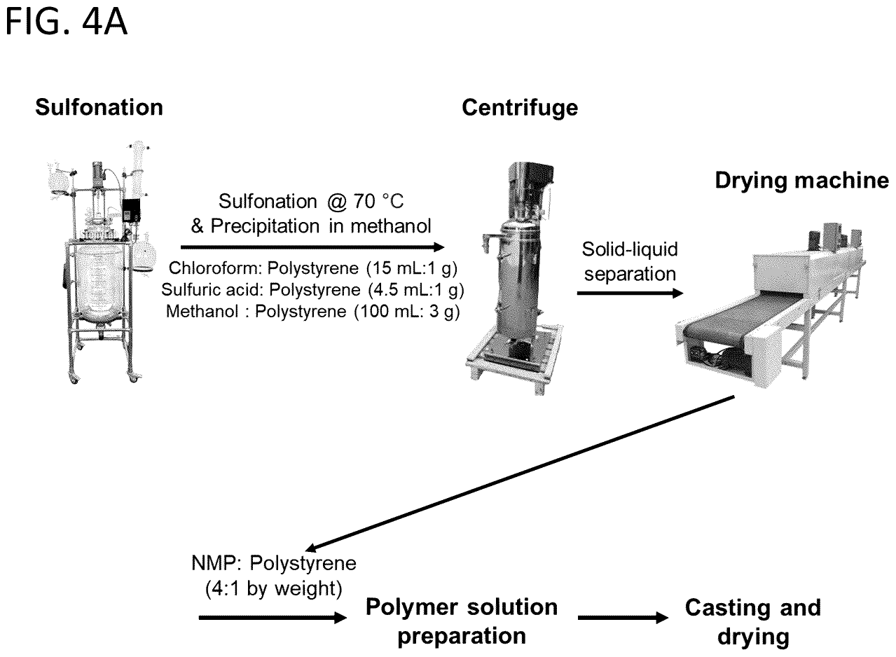

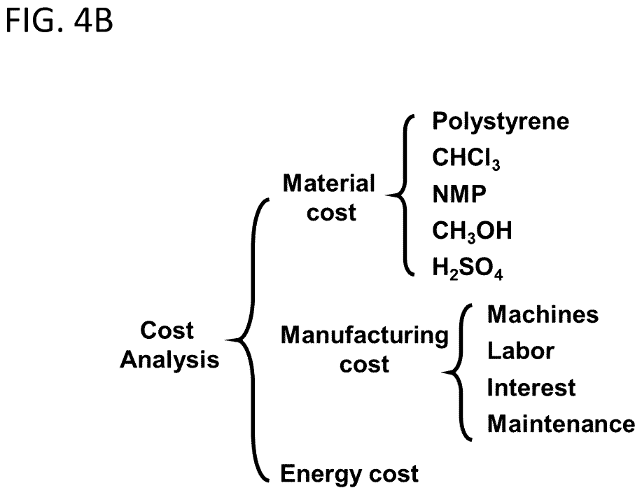

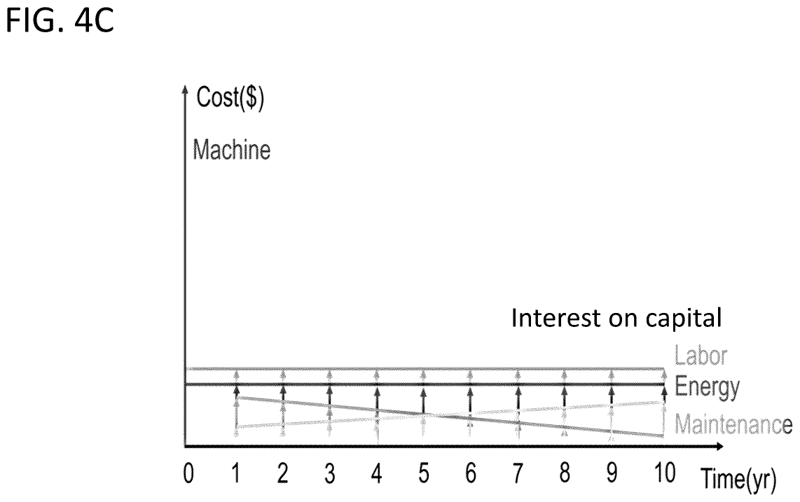

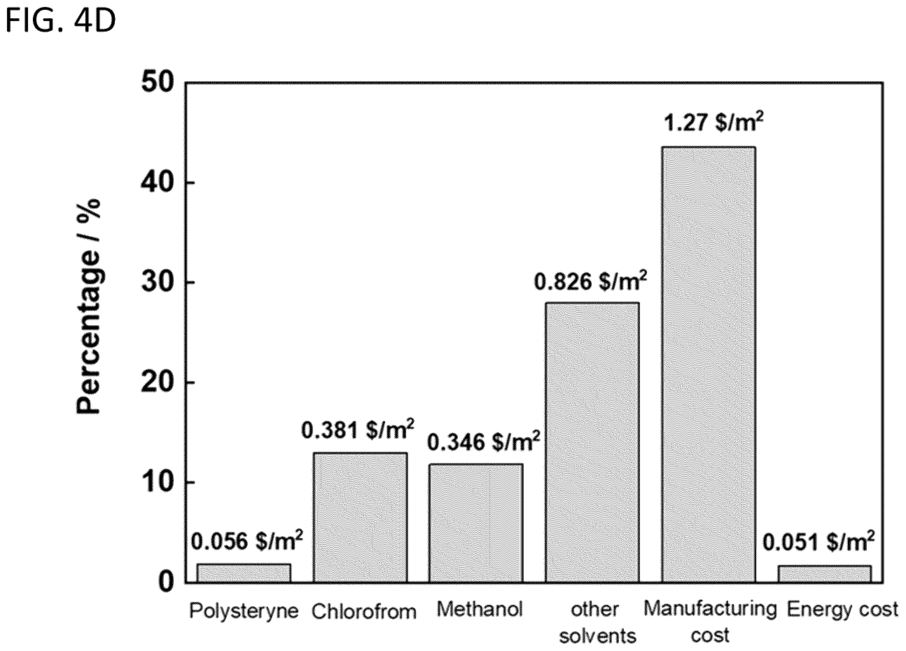

As incorporated into electrochemical devices, e.g., redox flow batteries, the ion exchange membranes fabricated by the present methods may be characterized by other properties relevant to such devices including coulombic efficiency and energy efficiency. These properties may be measured as described in the Example, below. As noted above, conditions of the present methods may be adjusted to achieve desired values for these properties. As described in the Example below and shown in FIGS. 3C-3G, an illustrative ion exchange membrane fabricated from sulfonated waste polystyrene exhibited very high efficiencies and stabilities. However, as compared to existing ion exchange membranes composed of Nafion, the present ion exchange membranes may be fabricated at a fraction of the cost. (See also FIGS. 4B-4D.)

Any of the disclosed ion exchange membranes and devices (e.g., redox flow batteries) comprising the ion exchange membranes are also encompassed by the present disclosure.

### EXAMPLE

This Example describes the one-pot sulfonation of industrial waste polystyrene (PS) plastics, including expanded polystyrene (EPS) and high-impact polystyrene (HIPS), into highly-valuable cation exchange membranes (CEMs) that exhibited excellent electrochemical performance in aqueous flow batteries.

### Materials and Methods

Synthesis of sulfonated polystyrene-based resins: 3 g of polystyrene (PS)-based material was dissolved in 45 mL chloroform (CHCl₃, Macron Fine Chemicals) in a round-bottom flask. 13.5 mL concentrated sulfuric acid (H₂SO₄, Sigma-Aldrich) was added into the PS solution. The sulfonation of PS was achieved by heating at 70° C. for different periods of time (70, 80 or 90 min). The sulfonated PS was precipitated using 500 mL methanol (VWR Avantor®) followed by washing with deionized (DI) water to remove H₂SO₄ from the sulfonated polymers. The synthesized sulfonated PS was dried at 60° C. The PS-based materials that were used included virgin polystyrene (VPS) and virgin high-impact polystyrene (VHIPS) which were purchased from Sigma-Aldrich and donated from Case Western Reserve University, respectively. Waste versions of these materials were obtained as follows. Waste expanded polystyrene (EPS) was collected from food dishes/cups. Waste high-impact polystyrene (HIPS) was collected from coffee caps. The sulfonated PS-based resins were named as follows: S-VPS-x (x=70, 80 or 90), S-VHIPS-y (y=70 or 80), S-EPS-W-dish and S-HIPS-W-cap. “S” refers to the incorporated sulfonate groups; “V” refers to virgin material, “W” refers to waste material, and x and y refer to the reaction time used during sulfonation. Optimized reaction times of 85 and 80 min were used for the waste EPS dish and waste HIPS cap, respectively.

Cation exchange membrane (CEM) preparation: The sulfonated PS-based resins were dissolved in N-methyl-2-pyrrolidone (NMP, Sigma-Aldrich) to form a 20 wt. % solution. The degassed sulfonated PS solution was cast onto a clean and dust-free glass plate via a doctor blade with a 200 μm gap height between the blade and surface to be coated and then dried at 50° C. for over 24 h. The sulfonated HIPS-based resins were dissolved in NMP to form a 30% solution. A sulfonated HIPS-based CEM was fabricated by casting onto a clear and dust-free glass plate via a doctor blade with a 200 μm gap height.

Thermogravimetric analysis (TGA): The thermal stability of different polymer samples was measured with a NETZSCH STA 449 F3 Jupiter under high purity argon atmosphere. The samples were poured in the clean alumina pan with cover, then heated to 800° C. at a rate of 10° C. min-1 continuously.

Uptake and swelling in electrolytes: The electrolyte uptake and swelling of membranes were measured by comparing weight and area of a dried membrane before and after immersing in the catholyte and anolyte for 24 h at room temperature.

The electrolyte uptake of a membrane can be calculated by Equation (1):

$$Electrolyte uptake = \frac{{W}_{after} - {W}_{before}}{{W}_{before}} \times 100 \% \qquad ( 1 )$$

where W_{before} and W_{after} are the weight of a membrane before and after immersing in electrolyte, respectively.

The swelling of a membrane can be calculated by Equation (2):

$$Swelling = \frac{{A}_{wet} - {A}_{dried}}{{A}_{dried}} \times 100 \% \qquad ( 2 )$$

where A_{wet} and A_{dried} are the area of the wet and dried membrane, respectively.

Ion exchange capacity (IEC): The traditional titration method was employed to determine the IEC of a membrane. Initially, the membranes were pretreated in 1M HCl to exchange all the cations to protons, and then immersed in the DI-water to remove excess HCl. The pretreated membranes were dried at 50° C. for 24 h. The dried membranes were immersed in 50 mL of 1M NaCl for 24 h at room temperature. Then the NaCl solution was titrated with ˜0.01 M NaOH solution by using phenolphthalein as an indicator. The IEC of a membrane can be calculated by Equation (3):

$$IEC = \frac{{c}_{NaOH} \times Δ {V}_{NaOH}}{{W}_{dried}} \qquad ( 3 )$$

where c_{NaOH} is the concentration of NaOH; AV is the consuming volume of NaOH solution; and W_{dried} is the weight of a dried membrane.

Cyclic Voltammetry (CV) test: CV testing was conducted on CH Instruments (CHI760D electrochemical workstation) by using a three-electrode configuration with a glassy carbon disk working electrode (the diameter of 3 mm), a silver/silver chloride reference electrode (Ag/AgCl with saturated KCl), and a Pt wire. The iR compensation was added before the CVs test, and the scan rate was set at 100 mV s⁻¹.

Attenuated total reflection-flourier transformed infrared spectroscopy (FTIR): Polymer chemical structures were characterized by flourier transform infrared spectroscopy (ATR-FTIR, PerkinElmer Spectrum 100 FTIR spectrometer). Each spectrum with transmittance mode was collected at a rate of 32 scans with a resolution of 4 cm⁻¹ and in the range from 500 cm⁻¹ to 4500 cm⁻¹.

Area specific resistance (ASR): The ASR of a membrane was measured in a flow battery, which was separated via the membrane with effective area of 2.4 cm². The membrane was pre-treated in supporting electrolytes for 24 h at room temperature. 10 mL of the 2 mol L⁻¹ supporting electrolytes were filled in both tanks. The resistance of a membrane was tested by using electrochemical impedance spectroscopy (EIS). The frequency range was from 1 MHz to 0.1 Hz. The ASR can be calculated by Equation (4):

$${r}_{ASR} = A ( {r}_{2} - {r}_{1} ) \qquad ( 4 )$$

where r_{ASR} is the area specific resistance, A is the effective area of a membrane, and r₂ and r₁ represent the resistance of H-cell with and without a membrane, respectively.

The permeability of a membrane in the catholyte and anolyte: The permeability of a membrane was measured by using a diffusion cell (H-cell). 6 mL of 0.2 mol L⁻¹ Na₄[Fe(CN)₆] in 1 mol L⁻¹ KOH and 6 mL of 2,6-DHAQ in 1 mol L⁻¹ KOH were filled in left and right chambers, respectively. The concentration of Na₄[Fe(CN)₆]/2,6-DHAQ in the chambers was measured at a regular time intervals by using cyclic voltammetry (CV) and UV-Vis instrument (Duetta-Horiba, Fluorescence and absorbance spectrometer). The permeability can be calculated by Fick's second law of diffusion, Equation (5).

$${V}_{r} \frac{{dc}_{t}}{dt} = A \frac{P}{l} ( {c}_{0} - {c}_{t} ) \qquad ( 5 )$$

where Vr is the volume of electrolyte; tis the test time; A is the effective area of the membrane; P is the permeability of active material, I is the thickness of a membrane; c₀ and cₜ are the pristine concentration of active material in the left chamber and concentration of active material in the right chamber at different test times.

Flow battery test: A single flow battery was assembled by sandwiching a membrane between two graphite felt electrodes, then clamped by two polar plates, and fixed by using a pair of polypropene end plates. The graphite felt (SGL Group, Wiesbaden, Germany) with an effective area of 2.4 cm² (1.5 cm×1.6 cm) was used.

0.2 mol L⁻¹ Na₄[Fe(CN)₆] in 1 mol L⁻¹ KOH and 0.1 mol L⁻¹ 2, 6-DHAQ in 1 mol L⁻¹ KOH were employed as catholyte and anolyte, respectively. The flow rate of electrolyte was about 20 ml min⁻¹. The cut-off voltages were set as 1.60 V or 1.65 V and 0.7 V, respectively. The flow battery was measured at current densities ranging from 40 to 100 mA cm⁻². The long-term stability of a membrane in a flow battery was cycled at the current density of 40 mA cm⁻².

Polarization test: The polarization curves of a flow battery were tested at different state of charges (SoC) (50%, 80% and 100%) using S-VPS-80 and Nafion 212 (NF212, Fuel Cell Store). The flow battery with a S-VPS-80 or NF212 was charged to different SoC and then discharged at alternating current densities. The discharge cell voltage was recorded at each current density.

Techno-economic analysis: The membrane cost analysis included material, manufacturing, and energy costs, and was calculated by Equation (6). In a large-scale manufacturing process, the amount of required waste PS materials was determined by Equation (7). The quantities of chloroform, NMP, sulfuric acid, and methanol can be calculated based on their respective ratios to PS, as specified in the experimental section. It is important to note that despite some materials, such as methanol and sulfuric acid, being reusable in laboratory fabrications, all solvents were assumed to be single-use due to their low cost and utilization. A 10% material waste was assumed for the entire process, implying that 90% PS membrane was produced from the initial input materials.

$$Membrane cost = \frac{Materials cost + Manufacturing cost + Energy cost}{The area of membrane made in 10 years} \qquad ( 6 )$$

$${m}_{PS} = \frac{{V}_{c} {t}_{w} wt}{{ρ}_{PS} ( 1 - {M}_{w} )} \qquad ( 7 )$$

where V_{c} is the casting speed; t_{w} is working hours; ρ_{PS} is the density of Noryl plastic; M_{w} is the material waste ratio during the casting process; w and t are the width and thickness of the complete membrane.

### The Characterization of Different Polystyrene Materials

To facilitate the upcycling of industrial waste plastics, the chemical structures of different PS-based materials were characterized by using FTIR and NMR. Commercial food dishes and coffee cups served as the primary raw materials for the production of CEMs. Virgin PS and virgin HIPS were utilized as reference materials for comparative analysis. As shown in FIG. 1B, FTIR spectra of virgin PS (VPS) and virgin HIPS (VHIPS) showed characteristic bands at 2900-3100 cm⁻¹, corresponding to C—H stretching vibration of benzene rings, along with bands at 1691 cm⁻¹, 1487 cm⁻¹, and 1450 cm⁻¹, attributed to C═C stretching vibrations in the benzene ring. The band at 1691 cm⁻¹ disappeared in the waste PS materials. Furthermore, as shown in FIG. 1C, a distinct peak at 965 cm⁻¹ was observed, which was attributed to the “C═C” functional groups of polybutadiene side chains in HIPS. This indicated that the commercial food dishes were composed of EPS, whereas the coffee caps were composed of HIPS.

To further elucidate the chemical structures of PS-based waste materials, different waste PS-based materials and virgin PS-based materials were characterized by ¹H-NMR. (FIGS. 1D-1F). The peaks at around 7.03-7.09 ppm, 6.93 ppm (shoulder peak), and 6.4-6.6 ppm resulted from different H atoms in the benzene ring. The peaks at 1.42 ppm and 1.83 ppm were attributed to H atoms in the polyethylene backbone. By contrast to PS, distinctive peaks were observed at 5.2-5.5 ppm and 0.5-2.5 ppm in the NMR spectra of HIPS, as shown in FIGS. 1E and 1F, respectively. These peaks were ascribed to the H atoms in the polybutadiene side chains of HIPS. These findings further confirmed that the commercial food dishes were composed of EPS materials, and the disposable coffee caps were composed of HIPS materials.

The molecular weight of the different PS-based materials was determined by gel permeation chromatography (GPC). As summarized in Table 1, below, the polymer molecular weights of different PS materials were about 368 kDa for VPS; 224 kDa for VHIPS; 230 kDa for HIPS from the waste coffee caps; and 271 kDa for PS from the waste dishes. The polydispersity index (PDI) was calculated and found to be 2.46 kDa for VPS; 2.73 kDa for VHIPS; 3.45 kDa for HIPS from the waste coffee caps; and 3.46 kDa for PS from the waste dishes. Thus, the PDI values for the waste plastic materials were significantly greater than for the virgin materials. PDI is a parameter that estimates the breadth of a polymer's molecule weight distribution. A PDI of 1 (M_{w}=Mₙ) indicates that the polymer contains equivalent length chains while a higher PDI (M_{w}>Mₙ) indicates the presence of some polymer chains with a smaller molecular weight.

TABLE 1
The molecular weight of different waste PS materials

| | M_{w} (Da) | Mₙ (Da) | PDI |
|---|---|---|---|
| virgin PS | 368495 | 150059 | 2.46 |
| virgin HIPS | 224238 | 82043 | 2.73 |
| waste HIPS caps | 230581 | 66819 | 3.45 |
| waste PS dishes | 271448 | 78532 | 3.46 |

### The Characterization of Sulfonated PS-Based Materials and Preparation of Cation Exchange Membranes

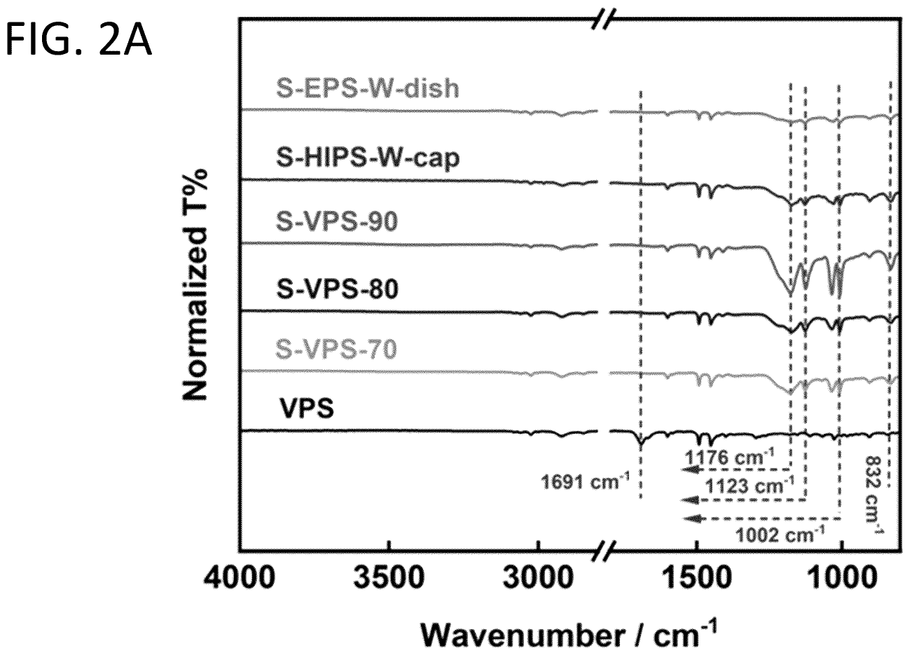

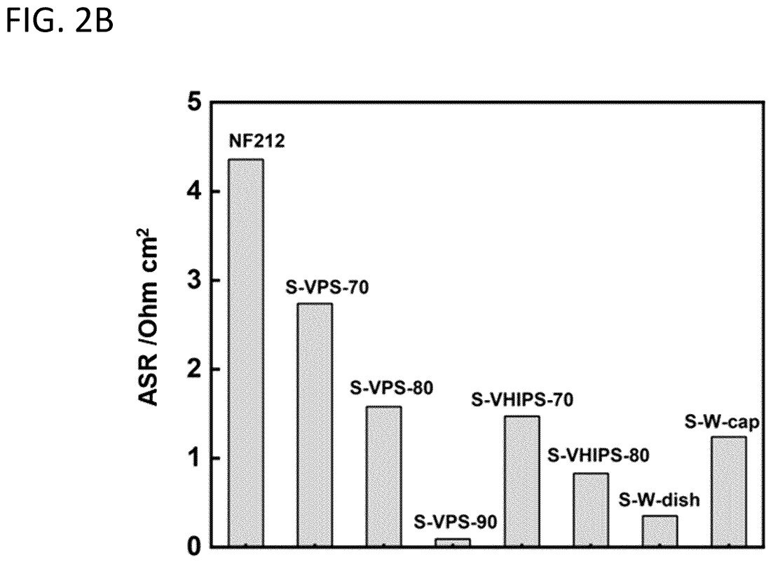

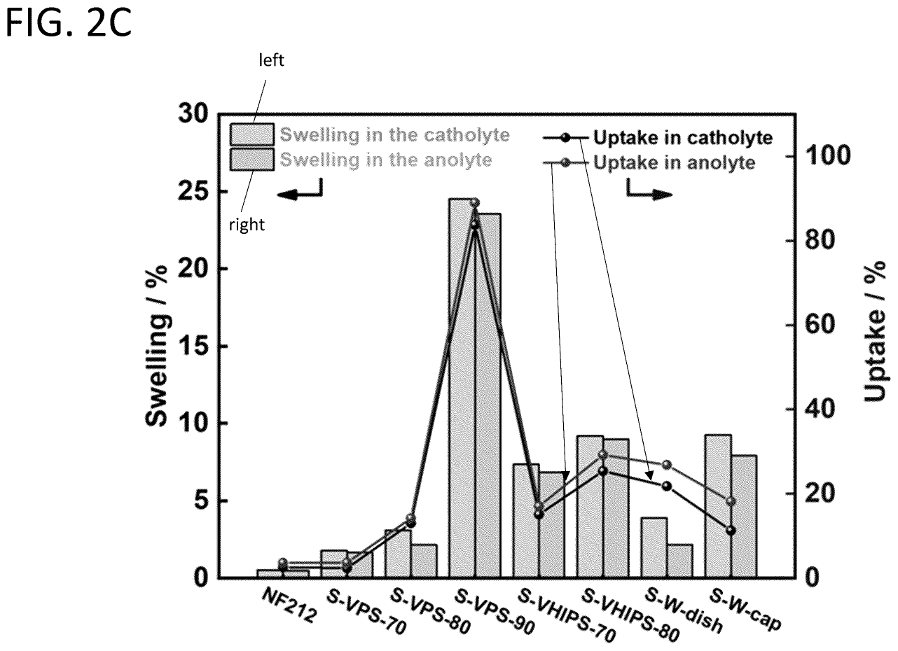

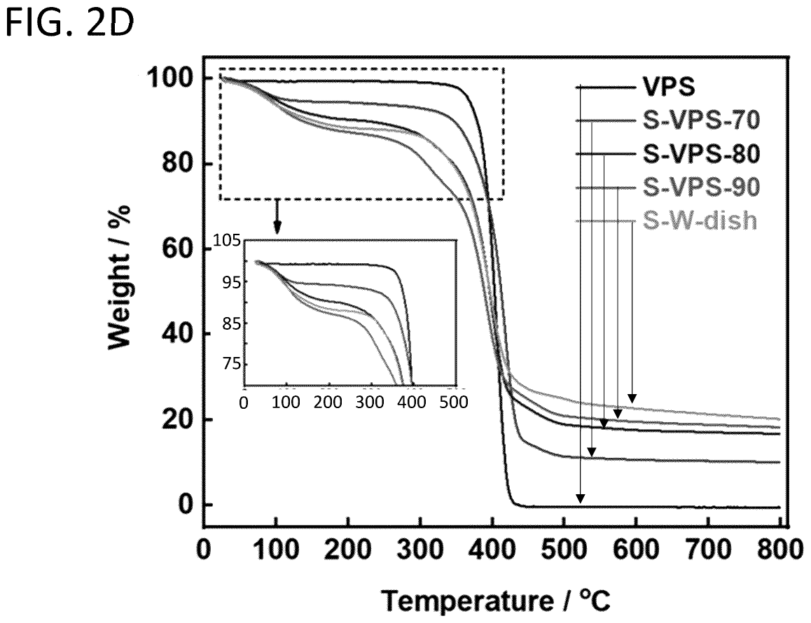

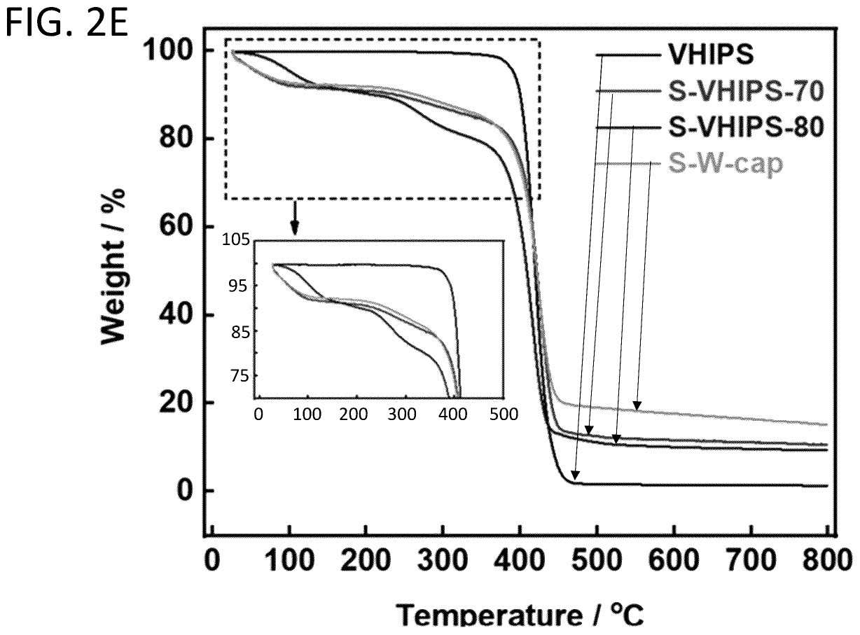

The VPS and waste PS-based plastics were sulfonated using concentrated H₂SO₄ and the degree of sulfonation was tuned by varying the reaction time. The chemical structures of sulfonated PS-based CEMs are shown in FIG. 1A. As shown in FIG. 2A, the disappearance of the band at 1691 cm⁻¹ was due to the substitution of the benzene ring with sulfonic acid groups. A stronger band at 1176 cm⁻¹ was also observed, which was assigned to the symmetric stretching vibration of sulfuric acid groups. The enhanced bands at 1123 cm⁻¹ and 1002 cm⁻¹ resulted from in-plane skeletal vibration and bending vibration of the benzene ring, respectively. The stronger peak at 834 cm⁻¹ indicated that the para-position of the benzene rings was sulfonated. Together, these results indicated that the PS-based materials were successfully sulfonated.

The PS-based cation exchange membranes (CEMs) were fabricated by doctor blade coating on a dust-free glass plate. The degree of sulfonation was measured by chemical titration method. As shown in Table 2, below (and other data not shown), longer sulfonation reaction times correlated with an increase in ion exchange capacity (IEC). The IECs of S-W-dish and S-W-cap were 1.04 mmol g⁻¹ and 0.80 mmol g⁻¹, respectively. Compared to sulfonated virgin PS-based CEMs, the IEC of S-W-dish and S-W-cap CEMs showed slightly lower IEC, which may be explained by the presence of inorganic additives in the commercial products. The area specific resistance (ASR) of a membrane strongly depended on its degree of sulfonation. As depicted in FIG. 2B, the ASR of PS-based CEMs decreased with increasing sulfonation reaction time. The S-VHIPS CEMs showed lower ASR than that of S-VPS CEMs which may be explained by the higher PDI of HIPS, which promotes sulfonation. Compared with NF212, the sulfonated PS-based CEMs demonstrated reduced ASR. Particularly, the optimal S-W-dish exhibited the lowest ASR.

TABLE 2
The physicochemical properties of NF212 and different PS-based CEMs.

| Properties | | NF212 | S-VPS-80 | S-W-dish | S-W-cap |
|---|---|---|---|---|---|
| Thickness | Dried | 48 ± 1 | 29 ± 1 | 29 ± 1 | 43 ± 1 |
| (μm) | Wet | 49 ± 1 | 30 ± 1 | 39 ± 1 | 44 ± 1 |
| ASR in 2M KOH (Ω cm²) | | 4.36 | 1.58 | 0.35 | 1.24 |
| Permeability | Na₄[Fe(CN)₆] | 4.64 × 10⁻¹¹ | 8.08 × 10⁻⁰⁹ | 1.55 × 10⁻⁰⁷ | 1.64 × 10⁻⁰⁸ |
| (cm² min⁻¹) | 2,6-DHAQ | 2.26 × 10⁻¹² | 2.59 × 10⁻¹⁰ | 7.98 × 10⁻⁰⁷ | 8.13 × 10⁻¹⁰ |
| Swelling (%) | Na₄[Fe(CN)₆] | 0.52 | 3.09 | 3.87 | 9.24 |
| | 2,6-DHAQ | 0.48 | 2.14 | 2.15 | 7.91 |
| Uptake (%) | Na₄[Fe(CN)₆] | 2.55 | 12.96 | 21.74 | 11.24 |
| | 2,6-DHAQ | 3.61 | 14.15 | 26.79 | 18.11 |

| | | | | |
|---|---|---|---|---|
| IEC (mmol g⁻¹) | 0.91 | 1.14 | 1.04 | 0.80 |

Furthermore, the sulfonation functionalization impacted the swelling and uptake of PS-based CEMs, thereby influencing permeability of PS-based membranes. As shown in FIG. 2C, the higher sulfonation of PS-based CEMs resulted in increased electrolyte swelling and uptake. The PS-based CEMs exhibited slightly higher swelling in the catholyte, along with more electrolyte uptake in the anolyte. NF212 showed the lowest swelling and uptake performance, consistent with its ASR. However, the increased swelling and uptake resulted in poor mechanical strength and higher permeability.

The permeabilities of PS-based CEMs and NF212 were estimated in catholyte and anolyte, respectively (See Table 2). The membrane thickness and degree of sulfonation played a very important role in its permeability. The dried S-VPS and S-W-dish CEMs had a thickness of around 30 μm, while dried S-VHIPS and S-W-cap were slightly thicker, ˜44 μm. With increasing degree of sulfonation, higher swelling and electrolyte uptake led to enhanced permeability across various PS-based membranes. Despite having a greater thickness, the S-VHIPS exhibited higher permeability, which was attributed to higher swelling and uptake.

Finally, the thermal stability of different PS-based CEMs were evaluated, and the results are shown in FIGS. 2E-2F. Compared to pristine VPS and VHIPS, the sulfonated PS-based resins showed notable weight loss between 50° C. and 140° C., which was associated with weight loss due to moisture absorption. The weight loss between 230° C. to 350° C. was ascribed to the desulfonation process. More weight loss was observed with a higher degree of sulfonation. The significant weight loss between 360° C. and 460° C. was attributed to the degradation of PS backbone.

### The Evaluation of PS-Based CEMs in Aqueous Flow Battery

The battery performance of upcycled PS-based CEMs was evaluated in an aqueous flow battery operating with Na₄[Fe(CN)₆] and 2,6-DHAQ (FIG. 3A). The cyclic voltammetry (CV) of Na₄[Fe(CN)₆] and 2,6-DHAQ were obtained as shown in FIG. 3B. The theoretical cell voltage was around 1.27 V. Results for the aqueous flow batteries assembled with different sulfonated PS-based CEMs are shown in FIGS. 3C-3D as well as other data not shown. The flow battery with S-VPS CEMs exhibited decreasing Coulombic efficiency (CE) and increasing voltage efficiency (VE), which was attributed to the influence of increasing degree of sulfonation on ionic conductivity and permeability. The optimal S-VPS-80 showed better flow battery performance, achieving a CE of 99.5% and an energy efficiency (EE) of 81.4% at 40 mA cm⁻². Like S-VPS CEMs, S-VHIPS CEMs showed similar results, with the flow battery using S-VHIPS-80 achieving optimal performance, with a CE of 99.5% and an EE of 84.5%. However, the S-VHIPS-90 CEM did not retain its integrity when submerged in water (data not shown). As shown in FIG. 3C, the S-W-dish achieved the best flow battery performance with a CE of 98.5% and an EE of 86.9%. The S-W-cap achieved performance similar to S-VHIP-80, consistent with the trend of ASR and permeability.

The battery performance at various current densities is shown in FIG. 3D. The flow battery performance tended to decrease with increasing current densities due to higher overpotential and polarization. However, the S-W-dish showed promising battery performance even at the current density of 100 mA cm⁻², maintaining an average CE of 99.9% and an average EE of 71.1%. As shown in FIG. 3E, owing to the outstanding membrane performance, the S-W-dish achieved a maximum power density of 220 mW cm⁻² at 50% state of charge (SoC) and higher discharge voltage compared to NF212, S-VPS-80, and S-W-cap. The higher power density was obtained with the rising electrolyte SoC, achieving the maximum power density of 290 mW cm⁻² at 100% SoC, as shown in FIG. 3F.

The long-term cycling performance of upcycled S-W-dish CEM was evaluated and the results are shown in FIG. 3G. The flow battery assembled with S-W-dish stably ran for 1200 charge-discharge cycles at 40 mA cm 2, which continuously cycled over 52 days. During cycling, an average CE of 99.3% and an EE of 83.2% were delivered. This result indicated that the upcycled PS-based S-W-dish CEM maintained excellent stability in an aqueous alkaline flow battery. To mitigate the negative effect of electrolyte degradation on cycling performance, the catholyte and anolyte were replaced by using fresh electrolytes after 333 cycles. The CVs of electrolytes after electrolyte substitution and cycling were obtained (data not shown). The increasing intensity of CVs after 1200 cycles may be attributed to the slightly increasing concentration due to water evaporation during long-term cycling. The chemical structure of S-W-dish after the cycling test was evaluated using FTIR spectroscopy (data not shown). After 1200 cycles, no additional peaks were observed in the FTIR spectroscopy of the S-W-dish membrane, suggesting the S-W-dish CEM had perfect stability in the alkaline aqueous flow battery.

### Techno-Economic Analysis for Upcycling PS Waste to Cation Exchange Membranes

A techno-economic model was established to evaluate the manufacturing cost of the PS-based CEM. The potential large-scale manufacturing process of PS-based CEMs is illustrated in FIG. 4A. The process begins with the dissolution of clean PS waste in chloroform, followed by the sulfonation process in a chemical reactor. The sulfonated PS polymer materials are then precipitated by adding methanol, and the solid and solvents are separated in a centrifuge. The solid is subsequently dried in a drying machine to remove residual solvents. Subsequently, the as-prepared sulfonated PS-based resins are dissolved in NMP with the assistance of an electric mixer. The resulting polymer solution is cast using a membrane casting machine to produce the upcycled PS CEMs with desired thickness. Finally, the process concludes with another drying step. The final cost of PS-based CEMs is expressed in dollars per square meter ($ m⁻²), enabling comparison to the currently commercial CEMs, such as Nafion series membranes, for aqueous flow batteries. The bottom-up cost model dissects the fabrication process into specific components, providing insight into a clear understanding of cost-intensive factors and facilitating adjustments to particular procedures in order to reduce the product cost. As illustrated in FIG. 4B, the membrane cost consists of material, manufacturing, and energy costs. The material costs include expenses for methanol, NMP, chloroform, sulfuric acid, and raw waste PS plastics. The manufacturing costs encompass machine investment, interest on capital investment, labor, energy, and machine maintenance costs. The cash flow representation in FIG. 4C displays the timeline for costs within each category. A manufacturing period of 10 years is assumed, equal to the projected lifetime of the membrane casting machine (See Table 3). Based on the potential large-scale manufacturing process and cost analysis method, FIG. 4E shows the cost distribution of each category and their respective contributions. Consequently, the unit price for fabricating the upcycled PS-based CEMs is determined to be 2.93 $·m⁻². The ultra-low cost of PS-based CEMs presents significant market opportunities for cation exchange membrane development and offers a strategic approach for the sustainable utilization of PS-based waste plastics.

TABLE 3
Key parameters and cost inputs for membrane fabrication.

| Membrane Casting | | |
|---|---|---|
| Property | Value | |
| Casting machine | $277,000 | |
| Casting speed | 5 m | · min⁻¹ |
| Maintenance cost | 3% | |
| Casting width | 0.98 | m |
| Membrane thickness | 0.03 | mm |
| Reactor | $6330 | unit⁻¹ |
| Centrifuge | $5800 | unit⁻¹ |
| Drying machine | $9999 | unit⁻¹ |
| Installed capacity | 162 | kW |
| Energy cost | 9.4 | cents · kWh⁻¹ |
| Polymeric solution | $6534 | unit⁻¹ |
| mixer | | |
| Labor | $38.91 | hr⁻¹ |
| Personnel required | 9 | |
| Annual working days | 340 | days |
| Daily working hours | 24 | hrs |

| | |
|---|---|
| Material waste | 10% |

Material

| | | |
|---|---|---|
| PS | $1.6 | kg⁻¹ |
| PS density | 1060 | kg · m⁻³ |
| Chloroform | $0.487 | kg⁻¹ |
| NMP | $5.7 | kg⁻¹ |
| Methanol | $0.37 | kg⁻¹ |
| Sulfuric acid | $0.06 | kg⁻¹ |

### CONCLUSION

This Example demonstrates the use of waste PS-based plastic materials for fabrication of highly-valuable CEMs for aqueous alkaline flow batteries. The waste dish and cap plastics that were used included expended polystyrene and high-impact polystyrene, respectively. The membrane properties of upcycled CEMs could be tuned by optimizing sulfonation time. The optimal sulfonated waste dish exhibited an ASR of 0.35 (2 cm², a Na₄[Fe(CN)₆] permeability of 1.55×10⁻⁷, and a 2,6-DHAQ permeability of 7.98×10⁻⁷. Despite the inherent trade-off between ionic conductivity and selectivity, the optimal sulfonated waste dish demonstrated remarkable battery performance. The flow battery using Na₄[Fe(CN)₆] and 2,6-DHAQ achieved a CE of 98.5% and an EE of 86.9% at a current density of 40 mA cm⁻², and an average CE of 99.9% and an average EE of 71.1% at 100 mA cm⁻². The flow battery with optimal sulfonated waste EPS stably ran for 1200 cycles with a CE of 99.3% and an EE of 83.2%, demonstrating that the upcycled sulfonated waste PS CEMs have promising stability for aqueous flow battery application. The technical-economic analysis based on material, manufacturing, and energy costs in a 10-year period shows that the proposed sulfonated waste PS-based CEMs has an ultra-low cost of 2.93 $·m⁻². The promising and sustainable strategy for the reutilization of industrial plastic materials offers significant environmental and economic benefits.

Additional information related to the Example, including information and data referenced as being not shown, may be found in U.S. Provisional Patent Application No. 63/734,300, filed on Dec. 16, 2024, the entire disclosure of which is incorporated herein by reference.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the invention. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The term “type” as used herein refers to chemical formula such that a single type means the same chemical formula and different type means different chemical formula. Similarly, use of “more” as in “one or more” refers to use of different types of the relevant entity.

Terms such as “comprising” and the like may be replaced with terms such as “consisting” and the like.

What is claimed is:

1. A method for fabricating an ion exchange membrane, the method comprising:
(a) exposing a polymer to an ionic functional group precursor under conditions to incorporate covalently bound ionic functional groups into the polymer, thereby providing a functionalized polymer comprising the covalently bound ionic functional groups; and
(b) forming the functionalized polymer into a membrane, thereby providing an ion exchange membrane that is permeable to some ions present in a fluid in contact with the membrane while impermeable to other ions present in the fluid.

2. The method of claim 1, wherein the polymer is a waste polymer.

3. The method of claim 2, wherein the waste polymer has a higher polydispersity index (PDI) as compared to its virgin form.

4. The method of claim 3, wherein the waste polymer has a PDI that is at least 1.4 times greater than its virgin form.

5. The method of claim 2, wherein the waste polymer is obtained from a consumer product.

6. The method of claim 1, wherein the polymer is an aromatic polymer comprising aromatic groups.

7. The method of claim 6, wherein the polymer comprises polymerized styrene.

8. The method of claim 6, wherein the polymer is a polystyrene, an acrylonitrile butadiene styrene (ABS), a styrene ethylene butylene styrene polymer (SEBS), a polyether sulfone (PES), a polyphenylene oxide) (PPO), or a combination thereof.

9. The method of claim 6, wherein the polymer is expanded polystyrene.

10. The method of claim 6, wherein the polymer is high impact polystyrene.

11. The method of claim 1, wherein the covalently bound ionic functional groups comprise covalently bound sulfonate groups, covalently bound carboxylate groups, or covalently bound quaternary ammonium groups.

12. The method of claim 1, wherein the covalently bound ionic functional groups comprise covalently bound sulfonate groups.

13. The method of claim 1, further comprising dissolving the polymer in a solvent prior to step (a).

14. The method of claim 1, wherein the membrane has a two-dimensional morphology and a thickness of less than 100 mm.

15. The method of claim 14, wherein the membrane is free-standing.

16. The method of claim 1, further comprising positioning the ion exchange membrane between an anode and a cathode of an electrochemical device.

17. The method of claim 16, wherein the electrochemical device is configured as a redox flow battery.

18. An ion exchange membrane fabricated according to the method of claim 1, the ion exchange membrane comprising a network of entangled chains of the functionalized polymer.

19. An electrochemical device comprising an anode, an anolyte in contact with the anode, a cathode in electrical communication with the anode, a catholyte in contact with the cathode, and an ion exchange membrane separating the anolyte and the catholyte, wherein the ion exchange membrane comprises a functionalized waste polymer comprising a waste polymer obtained from a consumer product and ionic functional groups covalently bound to the waste polymer.

20. The electrochemical device of claim 19, wherein the waste polymer is waste polystyrene and the ionic functional groups comprise sulfonate groups.
